(19) United States
(12) Patent Application Publication
(10) Pub. No.: US 2021/0236900 A1
(43) Pub. Date: Aug. 5, 2021

(54) RELAY RACE BATON EXCHANGE PLANNING SYSTEM, METHOD AND COMPUTER READABLE MEDIA

(71) Applicant: John Leedy, Mulberry, FL (US)

(72) Inventor: John Leedy, Mulberry, FL (US)

(21) Appl. No.: 16/779,357

(22) Filed: Jan. 31, 2020

(51) Int. Cl. A63B 69/00; G09B 5/02

(52) U.S. Cl. CPC A63B 69/0028; G09B 5/02

(57) ABSTRACT

Methods, systems and computer readable media for relay race exchange planning and visualization are described. The relay race exchange planning can be used for relay race training and performance optimization, among other things.

### TECHNICAL FIELD

Some implementations relate generally to computerized sports performance analysis and enhancement, and more particularly, to methods, systems and computer readable media for relay race baton exchange planning, training and/or performance.

### BACKGROUND

Relay race planning involves planning the coordinated exchange of a baton between two runners, an incoming runner and an outgoing runner. The incoming runner is the runner that has the baton and is completing a leg of the relay race. The outgoing runner is the runner that is to receive the baton passed form the incoming runner and begins a next leg of the relay race.

Because runners may have different top speeds and accelerations from start to top speed, there may be a need to plan certain parameters for a relay race event such as position of a setback for a “go” signal to signal the outgoing runner to being acceleration and an optional offset into an exchange zone for the outgoing runner to position himself/herself to await the “go” signal.

There may be a need to accurately determine the go signal setback position and the optional offset based on the attributes of the incoming and outgoing runners and to provide an indication of the setback and/or offset to runners and/or to coaching or support staff.

Some implementations were conceived in light of the above-mentioned needs, among other things.

### SUMMARY

Some implementations can include a computer implemented method. The method can include receiving, at a processing device, a list of runners and corresponding speeds and accelerations, and generating, at the processing device, an order of runners. The method can also include determining, at the processing device, an exchange time and distance for an exchange in a relay race event, and determining, at the processing device, a setback distance for an exchange go signal for the exchange. The method can further include determining, at the processing device, an offset into an acceleration zone for the exchange, and providing, for display by from processing device, the setback distance and the offset for the exchange.

Some implementations can include a system having one or more processors configured to perform operations. The operations can include receiving a list of runners and corresponding speeds and accelerations and generating an order of runners. The operations can also include determining an exchange time and distance for each exchange and determining a setback distance for an exchange go signal. The operations can further include determining an offset in an acceleration zone and displaying setback distance and offset for each exchange.

Some implementations can include a nontransitory computer readable medium having software instructions stored thereon that, when executed by a processor, cause the processor to perform operations. The operations can include receiving a list of runners and corresponding speeds and accelerations and generating an order of runners. The operations can also include determining an exchange time and distance for each exchange and determining a setback distance for an exchange go signal. The operations can further include determining an offset in an acceleration zone and displaying setback distance and offset for each exchange.

In any of the above implementations, the corresponding speeds and accelerations of runners in the list of runners can be determined based on data received from one or more devices worn by respective runners, wherein the devices include one or more of an acceleration measurement device, a location measurement device, a movement measurement device, and a body position measurement device. Generating the order of runners can include automatically determining an order of runners for the relay race event based on the speeds and accelerations of the runners so as to provide an order of runners having compatible speeds and accelerations for exchanges. Determining the exchange time and distance for each exchange includes determining a time and distance for an exchange based on the speeds and the accelerations of both an incoming runner and an outgoing runner for the exchange.

Determining the setback distance for the exchange go signal can include determining the setback distance that will correspond to an exchange occurring near a midpoint of an exchange zone based on the speeds and accelerations of both an incoming runner and an outgoing runner for the exchange. Determining the offset into the acceleration zone can include determining the offset that will correspond to an exchange occurring near a midpoint of an exchange zone based on the speed and acceleration of both an incoming runner and an outgoing runner for the exchange.

### BRIEF DESCRIPTION OF THE DRAWINGS

FIG. 1 is a diagram of an example relay race layout showing race legs and exchange zones for a four-person relay event.

FIG. 2 is a diagram of an example exchange zone showing setback for a “go” signal and an optional offset into the exchange zone for the outgoing runner starting position in accordance with some implementations.

FIG. 3 is a flow diagram of an example relay race baton exchange planning method in accordance with some implementations.

FIG. 4 is a flow diagram of an example method for relay race baton exchange parameter editing in accordance with some implementations.

FIG. 5 is a diagram of an example user interface for a relay race baton exchange application in accordance with some implementations.

FIG. 6 is a diagram of a user interface visualization of a relay race baton exchange course layout in accordance with some implementations.

FIG. 7 is a diagram of a user interface showing an augmented reality visualization of a relay race baton exchange course layout in accordance with some implementations.

FIG. 8 is a diagram of an example processing device to determine relay race planning parameters and visualizations in accordance with some implementations.

### DETAILED DESCRIPTION

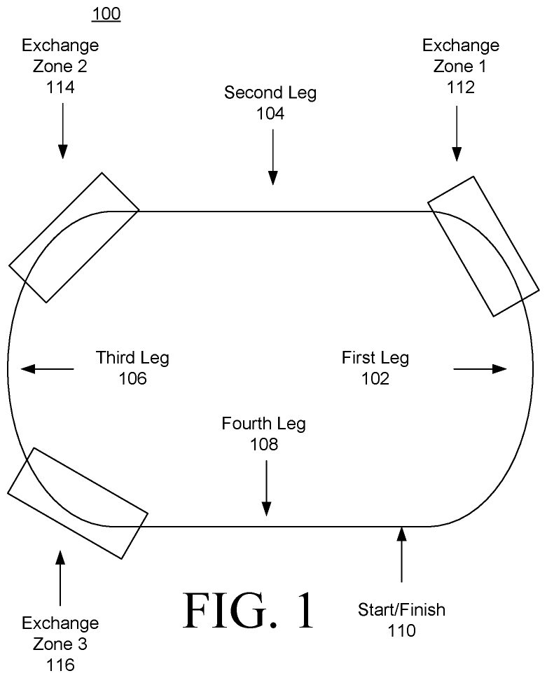

FIG. 1 shows an example relay race layout 100 including a start/finish line 110, a first leg 102, a second leg 104, a third leg 106 and a fourth leg 108. In between the legs are exchange zones (112, 114, and 116) in which a baton is exchange from an incoming runner to an outgoing runner. According to some rules, the exchange must occur within the exchange zone or the runners may be penalized or disqualified. It will be appreciated that the example relay race and exchange zone configuration is merely an example for illustration purposes. The exchange zones can include more or less exchange zones in different locations than shown. For example, in a mile relay race event the exchange zone for all three exchanges may be in the same location on the track or racecourse.

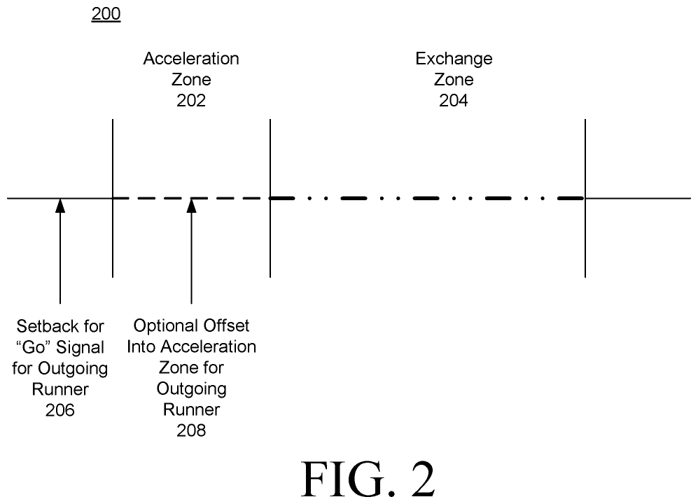

FIG. 2 shows detail of an example exchange zone 200 having an acceleration zone 202, an exchange zone 204 a setback for the go signal 206 and an optional offset into the acceleration zone for the outgoing runner 208.

It will be appreciated that the relay race diagram and exchange zone diagram are for illustration purposes and may not be to scale.

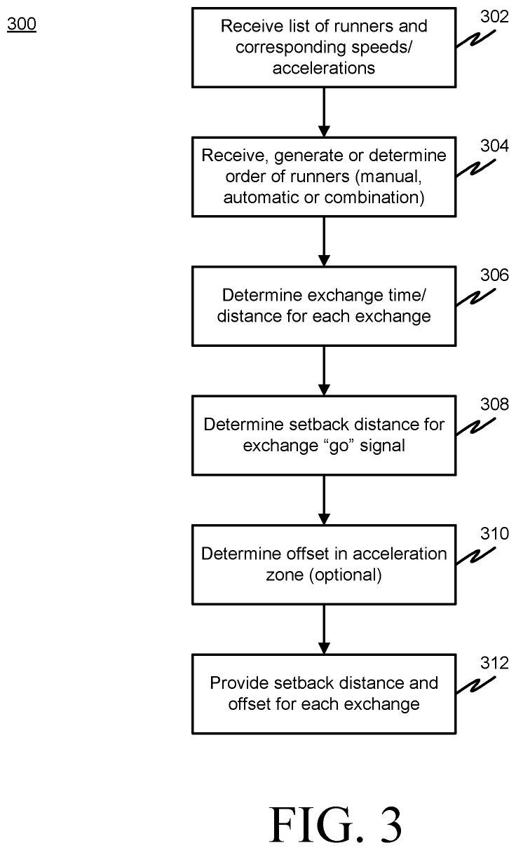

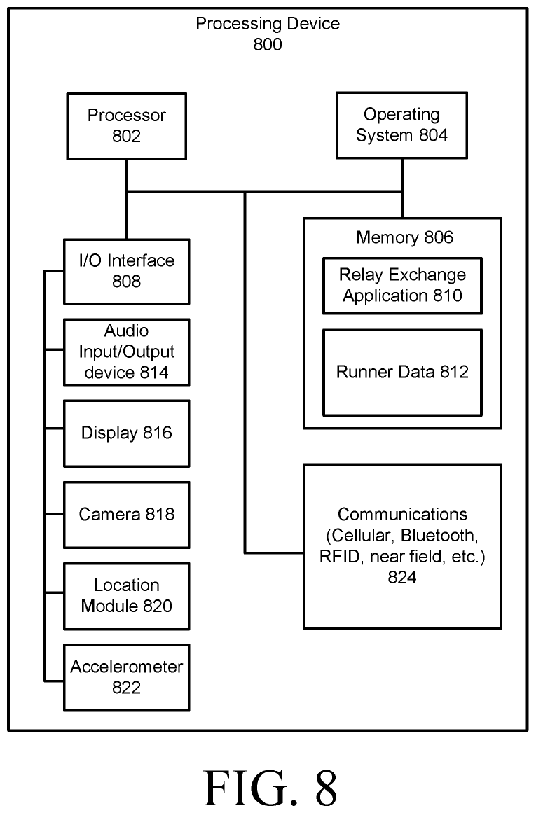

FIG. 3 is a flow chart of an example relay race baton exchange planning method in accordance with at least one embodiment. Processing begins at 302, where a list of runners and corresponding speed and acceleration data are received by a system (e.g., processing device 800 shown in FIG. 8). The list of runners and corresponding performance data can be entered by a user, obtained from a database (e.g., 812) or received from another system or one or more devices. Further, the performance data can be automatically obtained by providing sensors that can be attached to each runner to determine speed and acceleration (the automatic data collection can be used to determine initial parameters such as speed and acceleration and can also be used to analyze performance of runners in a relay race and correlate actual performance to plan). For example, the sensors can include one or more of a location sensor, one or more accelerometers, body position sensor(s), and movement sensor(s). Runner speed, acceleration, position etc. can also be determined using imaging devices. The speed can represent the speed of the runner as the runner approaches an exchange zone in a relay race (e.g., the speed over the last 30 meters of a 100-meter leg). The acceleration can represent the acceleration of a runner from standing start to full running speed (e.g., the acceleration of a runner in a relay race prior to baton exchange). Processing continues to 304.

At 304, an order of runners is received. The order of runners can be set manually, automatically or semi-automatically. Manual setting of the order can be done by a user through a user interface. Automatic setting of the order of runners can be done based on an optimization such as minimal total exchange time, minimal race time or the like (e.g., the system may determine possible combinations of runner exchanges and the times/distance for those exchanges prior to determining runner order). Semi-automatic order setting can include a manual indication of a certain position of one or more runners, with the remaining positions being determined automatically, or vice versa. Processing continues to 306

At 306, an exchange time and/or distance is determined for each exchange based on the speed of the incoming runner and the acceleration of the outgoing runner. Processing continues to 308.

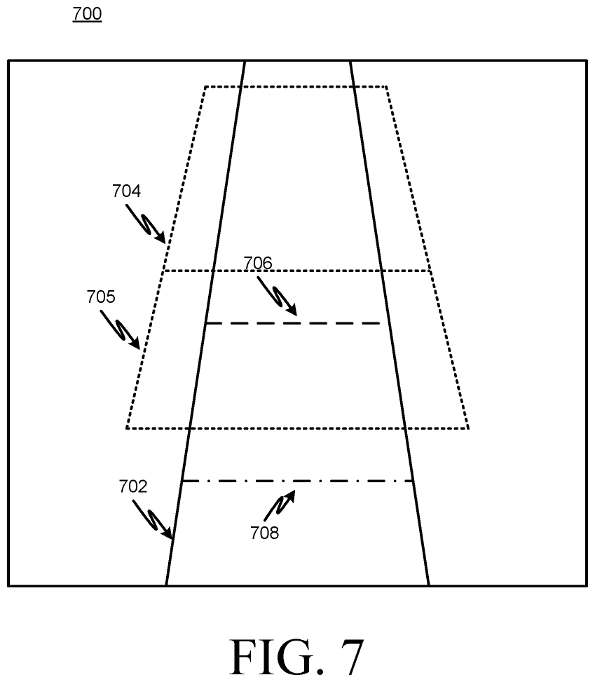

At 308, a setback for an exchange “go” signal is determined for each exchange. The setback represents a point at which the next runner is signaled to “go” or start running such that the baton exchange will occur at approximately the middle of the exchange zone. The signal can be provided vocally by the incoming runner. In another embodiment, runners can be outfitted with position (or time, distance or acceleration) measuring devices (e.g., a GPS or the like of a wireless device such as a phone or media player) and the go signal can be generated automatically by a signaling device (e.g., a speaker of a wireless device, a wired or wireless earphone, a wearable computing device, etc.) worn by the outgoing runner when an incoming runner reaches the setback point on the track. The distance for the setback can be marked on a track (e.g., with tape, paint or the like) for planning, training or competition purposes. The setback can also be visualized through an augmented reality system as shown in FIG. 7 and described below. Processing continues to 310.

At 310, an offset into the acceleration zone is optionally determined. The offset represents a distance into the acceleration zone where the next runner should be positioned for starting. The offset may be needed to compensate for differences between runners due to respective speed and/or acceleration of the incoming and outgoing runners. Processing continues to 312.

At 312, the setback (and offset if available) are displayed for each exchange thereby permitting athletes or coaching staff to plan, train and improve performance. The display can be sent to the display of a wireless device such as a phone or media player, the display can also be sent as an electronic message to another device and/or printed. It will be appreciated that 302-312 can be repeated in whole or in part to perform a contemplated relay race baton exchange planning task.

The method of FIG. 3 can be repeated or updated based on recent runner performance observations (e.g., timing data collected via observer with measurement instruments such as a stopwatch) or data collection from sensors during practice runs or actual competition heats.

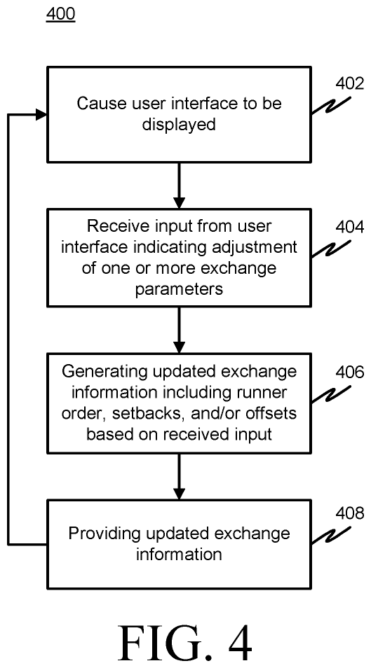

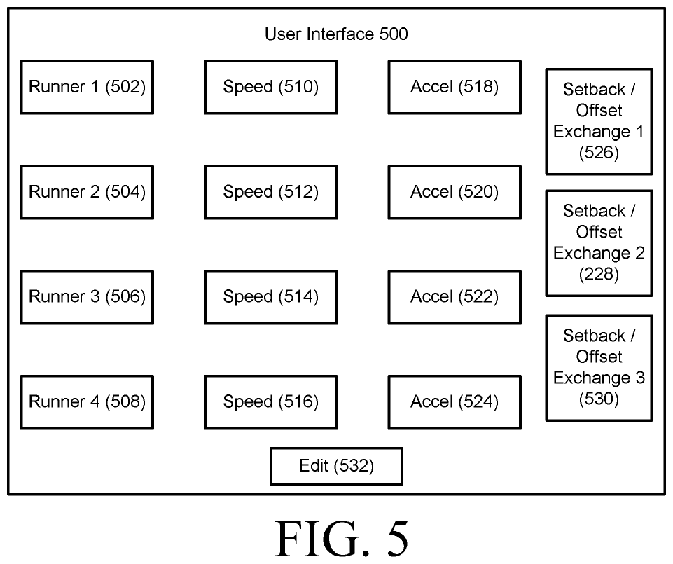

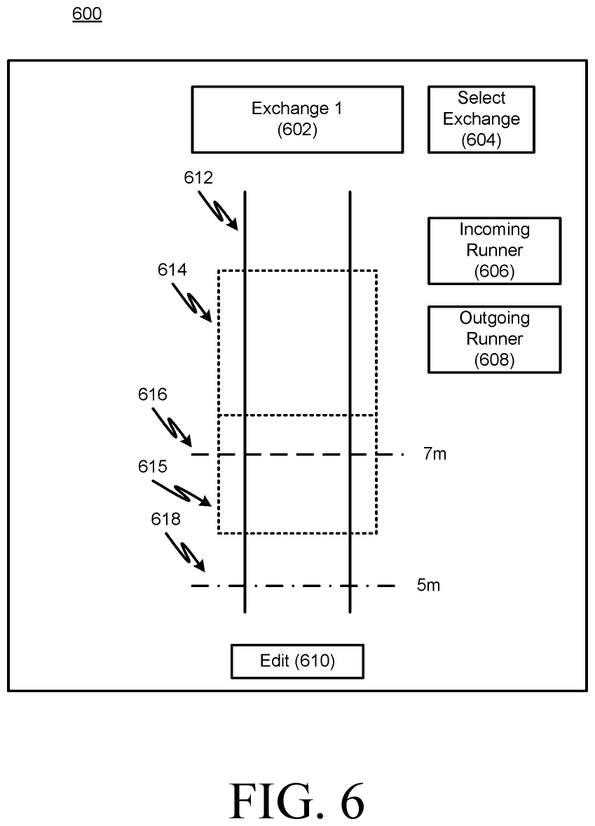

FIG. 4 shows a flow chart for providing a graphical user interface for editing relay race exchange parameters in accordance with some implementations. Processing begins at 402, where a user interface (e.g., as shown in FIG. 5, FIG. 6 or FIG. 7) is caused to be displayed. Processing continues to 404.

At 404, input from a user is received via the user interface indicating an adjustment or change to one or more of the relay exchange parameters (e.g., setback, offset, runners, etc.). The indication can include an indication that an edit element has been selected and adjusted data has been provided via the GUI. Processing continues to 406.

At 406, the system generates updated exchange information including runner selection or order, setbacks, and/or offsets based on received input. Processing continues to 408.

At 408, the updated exchange information is provided. For example, updated exchange information can be provided for displayed in a GUI such as those shown in FIGS. 5-7. Processing can continue to 402 to cause a GUI with the updated exchange information to be displayed.

FIG. 5 shows an example graphical user interface (GUI) 500 for relay race baton exchange planning. A list of runners (502-508) is displayed based on entered, received, retrieved or selected data (e.g., runner can be selected in the GUI from a roster of available runners shown in a list user interface element). For each runner, a corresponding speed (510-516) and acceleration (518-524) is displayed based on entered or retrieved data. Based on the runners and the corresponding speeds and accelerations, exchange setbacks and offsets (526-530) can be determined and displayed for each exchange. An edit button 532 (or other user interface element) can permit a user to edit the runners, speeds, accelerations, and/or setbacks and offsets.

In addition to, or as an alternative to, a tabular data or information display as shown in FIG. 5, a graphical visualization of the setbacks and/or offsets can be displayed. An example graphical visualization 600 is shown in FIG. 6. The visualization graphical interface 600 includes an element 602 showing the exchange for which a visualization is being displayed (other elements showing a race or team, or other levels of event or team information can also be displayed and/or selected). An element 604 can be provided to permit a user to select an exchange and/or a team or event. Further, in addition to a visualization, a go signal can be sent to the incoming runner and/or outgoing runner via a visual, audio or haptic signal to one or more of the runners via a device worn by the runner (e.g., a wristband, glasses, mobile device, or other wearable or portable device).

For a selected exchange (e.g., exchange 1), elements can display the incoming runner 606 and outgoing runner 608 names. Other information (e.g., race times, speed, acceleration, etc.) can also be displayed for each runner in respective elements.

The visualization interface 600 can include a graphical representation of a track lane 612, an exchange zone 614, an acceleration zone 615, an offset into the acceleration zone 616, a setback for the go signal 618, and an element 610 for editing the exchange parameters (e.g., one or more of setback, offset, runners, etc.).

FIG. 7 shows an example augmented reality visualization 700 for relay exchange parameters. In some implementations, the augmented reality visualization 700 can be displayed on a portable processing device such as a smart phone or a wearable device such as Google Glass, etc. The augmented reality visualization 700 includes an element representing a track lane 702, an exchange zone 704, an acceleration zone 705, an optional offset into the acceleration zone 706, and a setback for the go signal 708.

The above methods and user interfaces shown in FIGS. 3-7 can be implements as an application (or “app”) for a mobile device, as an application for use on a laptop or desktop computer, and as an application for use on a tablet or wearable device.

FIG. 8 is an example processing system 800 for relay race exchange planning and/or visualization in accordance with at least one embodiment. The processing system 800 includes a processor 802, operating system 804, memory 806 and I/O interface 808. The memory 806 can include a relay race exchange planning application 810 and a runner database 812. Input/output devices can include one or more of an audio input/output device 814, a display 816, a camera 818, a location module 820, and an accelerometer 822. The device 800 can also include communications modules 824 (e.g., one or more of cellular, Bluetooth, RFID, near field, Wi-Fi, or the like).

In operation, the processor 802 may execute the application 810 stored in the memory 806. The application 810 can include software instructions that, when executed by the processor, cause the processor to perform operations for electronic publishing in accordance with the present disclosure (e.g., performing one or more of steps 302-312 and/or 402-408 described above).

The application program 810 can operate in conjunction with the runner database 812 and the operating system 804. The processing system 800 can include a desktop computer, a laptop computer, a tablet computer, a media player, an ebook reader, a wireless phone, a smart phone, a wearable device (e.g., band, watch, glasses, etc.) or the like. The processing system 800 can also include a stand-alone device configured specifically for relay race exchange planning as described above.

Some implementations can include a stopwatch feature to collect runner speed and acceleration data. Also, speed and acceleration may be adjustable to account for runner fatigue, injury or the like. Distance of setbacks and offsets may be selectively displayed in feet, meters or steps (e.g., based on shoe size of person entered).

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C #.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and athletic arts.

Moreover, embodiments of the disclosed method, system, and computer readable media (or computer program product) can be implemented in software executed on a programmed general-purpose computer, a special purpose computer, a microprocessor, or the like.

It is, therefore, apparent that there is provided, in accordance with the various embodiments disclosed herein, methods, systems and computer readable media for relay race exchange planning and optimization.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A computer implemented method comprising:
receiving, at a processing device, a list of runners and corresponding speeds and accelerations;
generating, at the processing device, an order of runners;
determining, at the processing device, an exchange time and distance for an exchange in a relay race event;
determining, at the processing device, a setback distance for an exchange go signal for the exchange;
determining, at the processing device, an offset into an acceleration zone for the exchange; and
providing, for display by from processing device, the setback distance and the offset for the exchange.

2. The method of claim 1, wherein the corresponding speeds and accelerations of runners in the list of runners is determined based on data received from one or more devices worn by respective runners, wherein the devices include one or more of an acceleration measurement device, a location measurement device, a movement measurement device, and a body position measurement device.

3. The method of claim 1, wherein generating the order of runners includes automatically determining an order of runners for the relay race event based on respective speeds and accelerations of the runners so as to provide an order of runners having compatible speeds and accelerations for exchanges.

4. The method of claim 1, wherein determining the exchange time and distance for each exchange includes determining a time and distance for an exchange based on respective speeds and the accelerations of both an incoming runner and an outgoing runner for the exchange.

5. The method of claim 1, wherein determining the setback distance for the exchange go signal includes determining the setback distance that will correspond to an exchange occurring near a midpoint of an exchange zone based on respective speeds and accelerations of both an incoming runner and an outgoing runner for the exchange.

6. The method of claim 1, wherein determining the offset into the acceleration zone includes determining the offset that will correspond to an exchange occurring near a midpoint of an exchange zone based on respective speed and acceleration of both an incoming runner and an outgoing runner for the exchange.

7. A system comprising one or more processor configured to perform operations including:
receiving a list of runners and corresponding speeds and accelerations;
generating an order of runners;
determining an exchange time and distance for each exchange;
determining a setback distance for an exchange go signal;
determining an offset in an acceleration zone; and
displaying setback distance and offset for each exchange.

8. The system of claim 7, wherein respective speeds and accelerations of the runners is determined based on data received from one or more devices worn by respective runners, wherein the devices include one or more of an acceleration measurement device, a location measurement device, a movement measurement device, and a body position measurement device.

9. The system of claim 7, wherein generating the order of runners includes automatically determining an order of the runners based on respective speeds and accelerations of the runners so as to provide an order of runners having compatible speeds and accelerations for exchanges.

10. The system of claim 7, wherein determining the exchange time and distance for each exchange includes determining a time and distance for an exchange based on respective speed and acceleration of both an incoming runner and an outgoing runner for the exchange.

11. The system of claim 7, wherein determining the setback distance for the exchange go signal includes determining the setback distance that will correspond to an exchange occurring near a midpoint of an exchange zone based on respective speed and acceleration of both an incoming runner and an outgoing runner for the exchange.

12. The system of claim 7, wherein determining the offset into the acceleration zone includes determining the offset that will correspond to an exchange occurring near a midpoint of an exchange zone based on respective speed and acceleration of both an incoming runner and an outgoing runner for the exchange.

13. A nontransitory computer readable medium having software instructions stored thereon that, when executed by a processor, cause the processor to perform operations including:
receiving a list of runners and corresponding speeds and accelerations;
generating an order of runners;
determining an exchange time and distance for each exchange;
determining a setback distance for an exchange go signal;
determining an offset in an acceleration zone; and
displaying setback distance and offset for each exchange.

14. The nontransitory computer readable medium of claim 13, wherein respective speeds and accelerations of the runners is determined based on data received from one or more devices worn by the respective runners, wherein the devices include one or more of an acceleration measurement device, a location measurement device, a movement measurement device, and a body position measurement device.

15. The nontransitory computer readable medium of claim 13, wherein generating the order of runners includes automatically determining an order of the runners based on respective speeds and accelerations of the runners so as to provide an order of runners having compatible speeds and accelerations for exchanges.

16. The nontransitory computer readable medium of claim 13, wherein determining the exchange time and distance for each exchange includes determining a time and distance for an exchange based on respective speed and acceleration of both an incoming runner and an outgoing runner for the exchange.

17. The nontransitory computer readable medium of claim 13, wherein determining the setback distance for the exchange go signal includes determining the setback distance that will correspond to an exchange occurring near a midpoint of an exchange zone based on respective speed and acceleration of both an incoming runner and an outgoing runner for the exchange.

18. The nontransitory computer readable medium of claim 13, wherein determining the offset into the acceleration zone includes determining the offset that will correspond to an exchange occurring near a midpoint of an exchange zone based on respective speed and acceleration of both an incoming runner and an outgoing runner for the exchange.
